(19) United States
(12) Patent Application Publication
(10) Pub. No.: US 2012/0123985 A1
(43) Pub. Date: May 17, 2012

(54) OCCUPANT CLASSIFYING DEVICE FOR AN AUTOMOBILE

(76) Inventors: Young Joon KWON, Seoul (KR); Seong Hoon Lee, Yongin-si (KR); Soong Hyun Lee, Boryeong-si (KR)

(21) Appl. No.: 13/012,486

(22) Filed: Jan. 24, 2011

(30) Foreign Application Priority Data
Nov. 12, 2010 (KR) 10-2010-0112718

(51) Int. Cl. G06N 5/00; G06F 19/00

(52) U.S. Cl. 706/45; 702/65

(57) ABSTRACT

Provided is an occupant classifying device for an automobile which can classify an object in a seat without being influenced by external conditions that interfere in detecting a passenger.

The occupant classifying device for an automobile according to an exemplary embodiment of the present invention includes: a car body; a first electrode disposed in a seat inside the car body; a second electrode disposed in the seat; and a switch allowing the first electrode and the second electrode to have different polarities or the same polarity such that a first electric field is generated between the first electrode and the second electrode, or a second electric field is generated between the first and second electrodes and the car body.

### CROSS-REFERENCE TO RELATED APPLICATIONS

The present application claims priority to Korean Patent Application Number 10-2010-0112718 filed Nov. 12, 2010, the entire contents of which application is incorporated herein for all purposes by this reference.

### BACKGROUND OF THE INVENTION

1. Field of the Invention

The present invention relates to an occupant classifying device for an automobile, and more particularly, to an occupant classifying device for an automobile which classifies the occupant in a seat, using capacitance between two electrodes.

2. Description of the Related Art

In general, vehicles are equipped with various safety devices for the passenger's safety, and for example, one of them is the airbag that protects a passenger by inflating between the passenger and the structure of the vehicle in a vehicle collision.

The airbag protects a passenger while inflating by using pressure of a gas generated from a gas generator in a vehicle collision.

The airbag, however, is designed to inflate at a pressure for protecting common adults. Therefore, there is little problem when the passenger in the seat is an adult having a common body; however, the high inflation pressure of the airbag may be a factor threatening the passengers in the seat, when the passengers are infants, children, or small adults.

In general, although adults with a common body seat in the driver's seat, not only adults with a small body, but, infants, children, or small adults may seat in the passenger's seat.

Therefore, it is required to make the inflation pressure of the airbag different by classifying the passengers in the passenger's seat into an adult with a common body, an infant, a child, and a small adult.

It is prescribed in a law to make the inflation pressure of airbags different, depending on adults with a common body, infants less than one year old, infants less than three years old, children less than six years old, and 5% small women of the whole women, which are in the passenger's seat.

Therefore, vehicles are equipped with an occupant classifying device for classifying the passengers in the passenger's seat.

### SUMMARY OF THE INVENTION

The present invention has been made in effort to provide an occupant classifying device for an automobile which can classify the occupant in a seat without being influenced by external conditions that interfere in detecting a passenger.

The objects of the present invention are not limited to the object described above, and the other objects not stated in the above will be clearly understood by those skilled in the art from the following description.

An exemplary embodiment of the present invention provides an occupant classifying device for an automobile which includes: a car body; a first electrode disposed in a seat inside the car body; a second electrode disposed in the seat; and a switch allowing the first electrode and the second electrode to have different polarities or the same polarity such that a first electric field is generated between the first electrode and the second electrode, or a second electric field is generated between the first and second electrodes and the car body.

The details of other exemplary embodiments are included in the detailed description and the drawings.

According to exemplary embodiments of the present invention, since a switch is provided such that a first electrode and a second electrode, which are disposed in a seat, have different polarities or the same polarity, it is possible to classify an object in the seat without being influenced by external conditions that interfere in detecting a passenger, by using a first electric field generated between the first electrode and the second electrode, and a second electric field generated between the first and second electrodes and a car body.

The effects of the present invention are not limited to the effects described above, and the other effects not stated in the above will be clearly understood by those skilled in the art from claims.

### BRIEF DESCRIPTION OF THE DRAWINGS

FIG. 1 is a view illustrating the concept of an occupant classifying device for an automobile according to an exemplary embodiment of the present invention;

FIG. 2 is a view showing a first electrode, a second electrode, and a control unit, which are shown in FIG. 1;

FIG. 3 is a block diagram of FIG. 2;

FIG. 4 is a table showing classification modes set in advance by a controller of an occupant classifying device for an automobile according to an exemplary embodiment of the present invention, and the result of the classification modes; and

FIG. 5 is a flowchart illustrating a method of controlling an occupant classifying device for an automobile according to an exemplary embodiment of the present invention.

### DETAILED DESCRIPTION OF THE EMBODIMENTS

Advantages and features of the present invention and methods for achieving them will be made clear from exemplary embodiments described below in detail with reference to the accompanying drawings. However, the present invention is not limited to exemplary embodiments described herein and will be implemented in various forms. The exemplary embodiments are provided by way of example only so that a person of ordinary skill in the art can fully understand the disclosures of the present invention and the scope of the present invention. Therefore, the present invention will be defined only by the scope of the appended claims. Like reference numerals designate like components throughout the specification.

An occupant classifying device for an automobile according to an exemplary embodiment of the present invention is described hereafter with reference to the accompanying drawings.

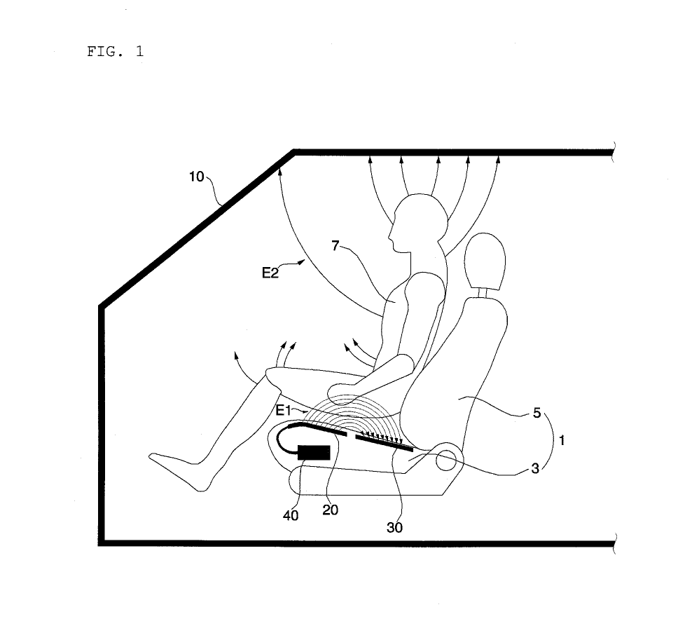

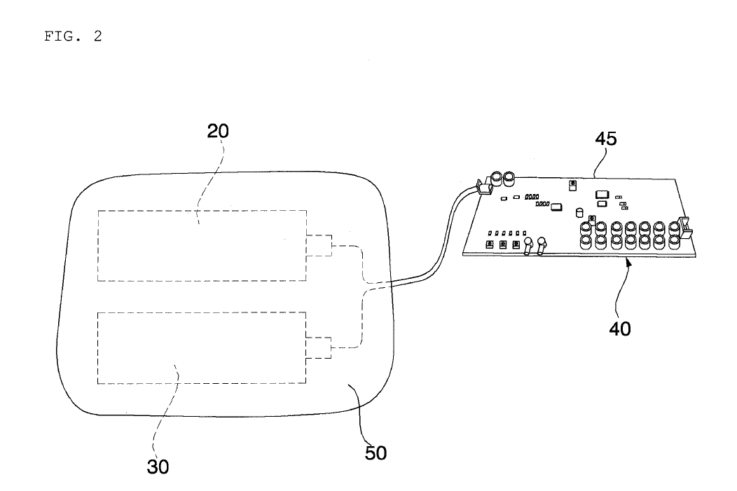

FIG. 1 is a view illustrating the concept of an occupant classifying device for an automobile according to an exemplary embodiment of the present invention, FIG. 2 is a view showing a first electrode 20, a second electrode 30, and a control unit 40, which are shown in FIG. 1, and FIG.

3 is a block diagram of FIG. 2.

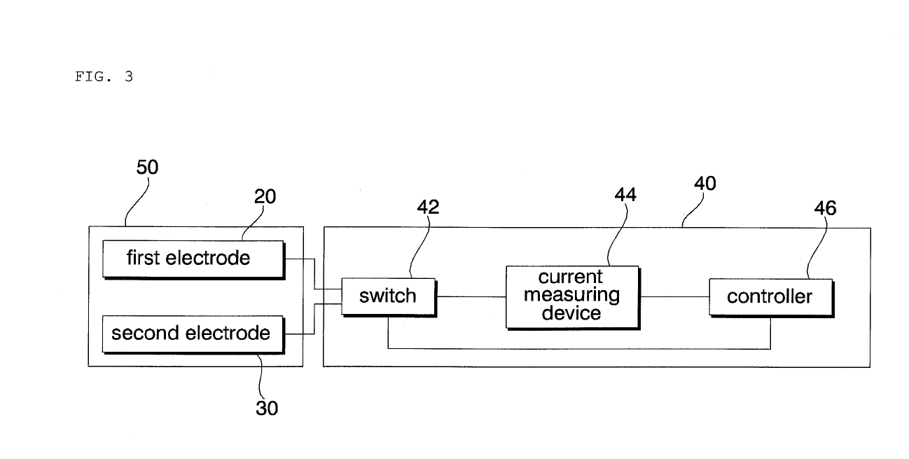

Referring to FIGS. 1 to 3, an occupant classifying device for an automobile according to the exemplary embodiment of the present invention includes a car body 10, a first electrode 20 disposed in a seat 1 inside the car body 10, a second electrode 30 disposed in the seat 1, and a control unit 40.

The first electrode 20 and the second electrode 30 are embedded in a sensor mat 50, at a predetermined distance from each other, and electrically connected with the control unit 40 and made in a module. The first electrode 20, second electrode 30, and control unit 40, which are made in a module as described above, can be easily installed in a seat 1. The control unit 40 may not be necessarily installed in the seat in this configuration. That is, the control unit 40 may be an ECU (Electronic Control Unit) that is a typical control device of vehicles.

The car body 10, first electrode 20, second electrode 30, and control unit 40 are electrically connected with a battery in the vehicle. That is, the negative terminal of the battery is connected to the car body 10, such that an electric circuit composed of the car body 10, first electrode 20, second electrode 30, and control unit 40 can be implemented.

The seat 1 has a seating part 3 where the hip of an occupant 7 is placed and a back 5 supporting the back of the occupant 7. The first electrode 20 and the second electrode 30 may be disposed in the seating part 3 of the seat 1 or in the back 5. Hereinafter, it is assumed that the first electrode 20 and the second electrode 30 are disposed in the seating part 3 of the seat 1 and the seat 1 implies the seating part 3. Further, the occupant 7 is an example of objects that are placed on the seat 1 and the objects that are placed on the seat 1 are variable. That is, the seat 1 may be empty, an adult 1 with a common body may sit on the seat 1, an adult with a small body may be sit on the seat 1, with a cushion or thick cloth therebetween, a CRS (Child Restraint System) with an infant may be mounted on the seat 1, electronic devices, such as a mobile phone, may be placed on the seat 1, and water may be spilled on the seat 1.

The occupant classifying device for an automobile according to the exemplary embodiment of the present invention is a part of technologies for controlling inflation of an airbag and the inflation pressure in accordance with classification of occupants in the seat 1, and hereinafter, the object in the seat 1 is given a reference numeral 7, the same as the passenger 7 and the object 7 in the seat 1 is described.

The control unit 40 includes a switch 42, a current measuring device 44, and a controller 46. The switch 42, current measuring device 44, and controller 46 may be integrated in the ECU. Further, the switch 42 and the current measuring device 44 may be mounted on a circuit board 45 in the seat 1 and the controller 46 may be disposed in the ECU and connected with the circuit board 45.

The switch 42 is an analogue switch included in the control unit 40.

The switch 42 is connected to the first electrode 20 and the second electrode 30 and transmits AC power of the battery to the first electrode 20 and the second electrode 30. The switch 42 is activated such that the first electrode 20 and the second electrode 30 have different polarities or the same polarity.

When the switch 42 is activated such that the first electrode 20 and the second electrode 30 have different polarities, the first electrode 20 and the second electrode 30 alternately operate as the positive electrode and the negative electrode. Hereafter, for the convenience of understanding the description, it is assumed that when the first electrode 20 and the second electrode 30 have different polarities, the first electrode 20 is the positive electrode and the second electrode 30 is the negative electrode.

Further, when the switch 42 is activated such that the first electrode 20 and the second electrode 30 have the same polarity, the first electrode 20, the second electrode 30, and the car body 10 alternately operate as the positive electrode and the negative electrode. Hereafter, for the convenience of understanding the description, it is assumed that when the first electrode 20 and the second electrode 30 have the same polarity, the first electrode 20 and the second electrode 30 are both the positive electrode while the car body 10 is the negative electrode.

When the first electrode 20 is the positive electrode and the second electrode 30 is the negative electrode, a first electric field E1 is produced between the first electrode 20 and the second electrode 30.

Further, when the first electrode 20 and the second electrode 30 are both positive electrodes and the car body 10 is the negative electrode, a second electric field E2 is generated between the first and second electrodes 20, 30 and the car body 10.

The switch 42 is periodically activated within a very short time such that the first electric field E1 and the second electric field E2 can be alternately generated.

The controller 46 classifies the object 7 in the seat 1, using a value outputted due to disturbance of the first electric field E1 when the object 7 in the seat 1 is exposed to the first electric field E1 and a value outputted due to disturbance of the second electric field E2 when the object 7 in the seat 1 is exposed to the second electric field E2.

The value outputted due to the disturbance of the first electric field E1 and the value outputted due to the second electric field E2 may be current I measured by the current measuring device 44 or capacitance C calculated from the current I by the controller 46. In the exemplary embodiment, the controller 46 calculates the capacitance from the current C I and classifies the object 7 in the seat 1 on the basis from the capacitance C.

The current measuring device 44 measures the current I due to disturbance of the first electric field E1 when the object 7 in the seat 1 is exposed to the first electric field E1 and the current I due to disturbance of the second electric field E2 when the object 7 in the seat 1 is exposed to the second electric field E2.

The controller 46 classifies the object 7 in the seat 1 by calculating capacitance C from the current I due to the disturbance of the first electric field E1 measured by the current measuring device 44, calculating capacitance C from the current I due to the disturbance of the second electric field E2, and comparing the capacitances C with predetermined critical values in the controller 46.

In general, the intensity of an electric field is in inverse proportion to the square of distance between two electrodes by Coulomb's law, such that the closer the two electrodes, the larger the intensity of the electric field. Therefore, since the first electrode 20 and the second electrode 30 are both disposed in the seat 1 in the occupant classifying device for an automobile according to the exemplary embodiment of the present invention, the distance between the first electrode 20 and the second electrode 30 is small, such that the intensity of the first electric field E1 is large; therefore, the sensing sensitivity can be improved, when the electric field E1 is involved in detecting the object 7 in the seat 1.

Further, the larger the distance between two electrodes, the more the electric field spread in all directions. Therefore, the electric field spreads in all directions and only some of the electric field is involved in detecting the object 7 in the seat 1, when the distance between the first electrode 20 and the second electrode 30 is large, such that the sensing sensitivity may reduce. Accordingly, the seat 1 is provided with an insulator to prevent the electric field from spreading in all directions when the distance between the first electrode 20 and the second electrode 30 is large; however, in the occupant classifying device for an automobile according to the exemplary embodiment of the present invention, it is possible to remove the insulator when the first electrode E1 is involved in detecting the object 7 in the seat 1, because the first electrode 20 and the second electrode 30 are disposed close to each other in the seat 1.

Further, since the first electric field E1 generated between first electrode 20 and the second electrode 30 is limited in the seat 1, when the first electric field E1 is involved in detecting the object 7 in the seat 1, it is possible to minimize that the first electric field E1 interferes with the electro magnetic waves from electronic devices and disperses, such that the sensing sensitivity is improved.

However, when only the first electric field E1 is involved in detecting the object 7 in the seat 1, it could be seen that the object 7 in the seat 1 was misrecognized as an adult, even though the seat is empty 1, when water was spilled on the seat 1 or an electronic device with the power adaptor turned off was on the seat 1. Further, it could be seen that when an adult with a small body sit on the seat 1, with a cushion or thick cloth therebetween, the object 7 in the seat 1 is not recognized as the adult with a small body.

The switch 42 is provided to prevent the misrecognition of the object 7 in the seat 1 and is activated such that the first electrode 20 and the second electrode 30 have different polarities and the first electric field E1 is generated between the first electrode 20 and the second electrode 30, or the first electrode 20 and the second electrode 30 have the same polarity and the second electric field E2 is generated between the first and second electrodes 20, 30 and the car body 10 to be involved in detecting the object 7 in the seat 1. Therefore, it is possible to clearly classify the object 7 in the seat 1, even if water is spilled on the seat 1, an electronic device with the power adapter turned off is placed on the seat 1, or an adult with a small body sits on the seat 1, with a cushion or thick cloth therebetween.

The current I depends on disturbance of the electric field generated between two electrodes. That is, the current I depends on disturbance of the first electric field E1 generated between the first electrode 20 and the second electrode 30 and also depends on disturbance of the second electric field E2 generated between the first and second electrodes 20, 30 and the car body 10. Therefore, the current I depends on permittivity of the object 7 in the seat 1.

In general, the permittivity of air is about 1, the permittivity of water is 80, the permittivity of moisture (gas) is 1, the permittivity of ice is 100, and the permittivity of plastics is 2 to 3, which have different values.

Therefore, as can be seen from the following [Formula 1], the capacitance C between the first electrode 20 and the second electrode 30 depends on the permittivity of the object between the first electrode 20 and the second electrode 30,

$$C = ɛ \frac{A}{d} \qquad [ Formula 1 ]$$

where C is capacitance, ε is permittivity, A is the sum of areas of the first electrode 20 and the second electrode 30, and d is the distance between the first electrode 20 and the second electrode 30.

The controller 46 can acquire the capacitance C from the following [Formula 2], using the current I measured by the current measuring device 44,

$$I = C \frac{d V}{d t} \qquad [ Formula 2 ]$$

where I is the current measured by the current measuring device 44, C is capacitance, and V is voltage of the AC power. That is, the current I measured by the current measuring device 44 is the same as a value obtained by multiplying the value, which is obtained by differentiating the voltage V of the AC power to time, by the capacitance C between the first electrode 20 and the second electrode 30.

The controller 46 classifies the object 7 in the seat 1 by comparing the capacitance C calculated from the current I measured by the current measuring device 44 with the predetermined critical values in the controller 46.

Further, a plurality of classification modes for classifying the object 7 in the seat 1 is set in advance in the controller 46. The controller 46 classifies the object 7 in the seat 1 by selecting one of the classification modes.

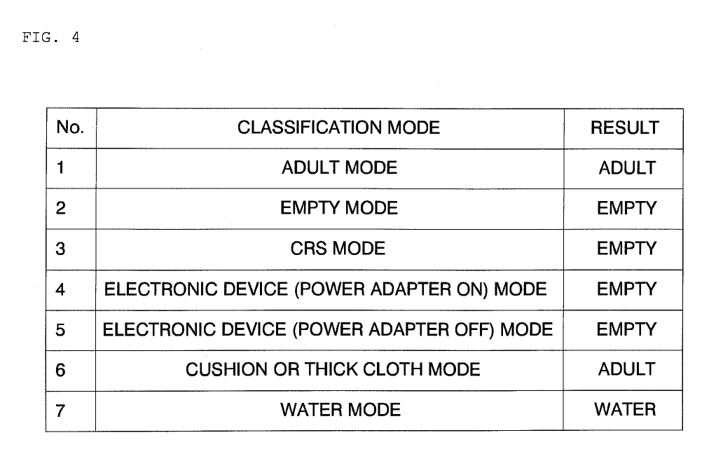

FIG. 4 is a table showing classification modes set in advance by a controller of an occupant classifying device for an automobile according to an exemplary embodiment of the present invention, and the results of the classification modes.

Referring to FIG. 4, the classification modes set in advance in the controller 46 include an adult mode, an empty mode, and CRS mode, an electronic device-on mode, an electronic device-off mode, a cushion or thick cloth mode, and a water mode.

If the controller 46 classifies the object 7 in the seat 1 as an adult by selecting the adult mode, the airbag is supposed to inflate because the object 7 in the seat 1 is an adult. Therefore, when classifying the object 7 in the seat 1 as an adult by selecting the adult mode, the controller 46 finally determines the object 7 in the seat 1 as an adult such that the airbag can inflate.

Further, when the controller 46 classifies the object 7 in the seat 1 as an empty space by selecting the empty mode, the airbag is not supposed to inflate because the object 7 in the seat 1 is an empty space. Therefore, when classifying the object 7 in the seat 1 as an empty space by selecting the empty mode, the controller 46 finally determines the object 7 in the seat 1 as an empty space such that the airbag does not inflate.

Further, when the controller 46 classifies the object 7 in the seat 1 as a CRS by selecting the CRS mode, the airbag is not supposed to inflate such that the infant is not injured by the inflation pressure of the airbag because the object 7 in the seat 1 is an infant lying in the CRS. Therefore, when classifying the object 7 in the seat 1 as a CRS by selecting the CRS mode, the controller 46 finally determines the object 7 in the seat 1 as an empty space such that the airbag does not inflate.

Further, when the controller 46 classifies the object 7 in the seat 1 as an electronic device by selecting one of the electronic device-on mode and the electronic device-off mode, the airbag is not supposed to inflate because the object 7 in the seat 1 is an electronic device. Therefore, when classifying the object 7 in the seat 1 as an electronic device by selecting one of the electronic device-on mode and the electronic device-off mode, the controller 46 finally determines the object 7 in the seat 1 as an empty space such that the airbag does not inflate.

Further, when the controller 46 classifies the object 7 in the seat 1 as a cushion or thick cloth by selecting the cushion or thick cloth mode, the airbag is supposed to inflate, because the object 7 in the seat 1 may be a passenger with a small body on a cushion or thick cloth in the seat 1. Therefore, when classifying the object 7 in the seat 1 as a cushion or thick cloth by selecting the cushion or thick cloth mode, the controller 46 finally determines the object 7 in the seat 1 as an adult such that the airbag can inflate.

Further, when the controller 46 determines the objects 7 in the seat 1 as water by selecting the water mode, it is supposed to remove the water from the seat for exact classification, because the water is on the seat 1. Therefore, classifying the object 7 in the seat 1 as water by selecting the water mode, the controller 46 finally determines the object 7 in the seat 1 as water and can inform the passenger that water is on the seat 1, by operating a warning device (a lamp or a buzzer).

The controller 46 classifies the object 7 in the seat 1 by comparing the value (capacitance in this exemplary embodiment) outputted due to disturbance of the first electric field E1 with the predetermined critical values, comparing the value (capacitance in this exemplary embodiment) outputted due to disturbance of the second electric field E2 with the predetermined critical values, and selecting one of the classification modes, which is described hereafter in detail.

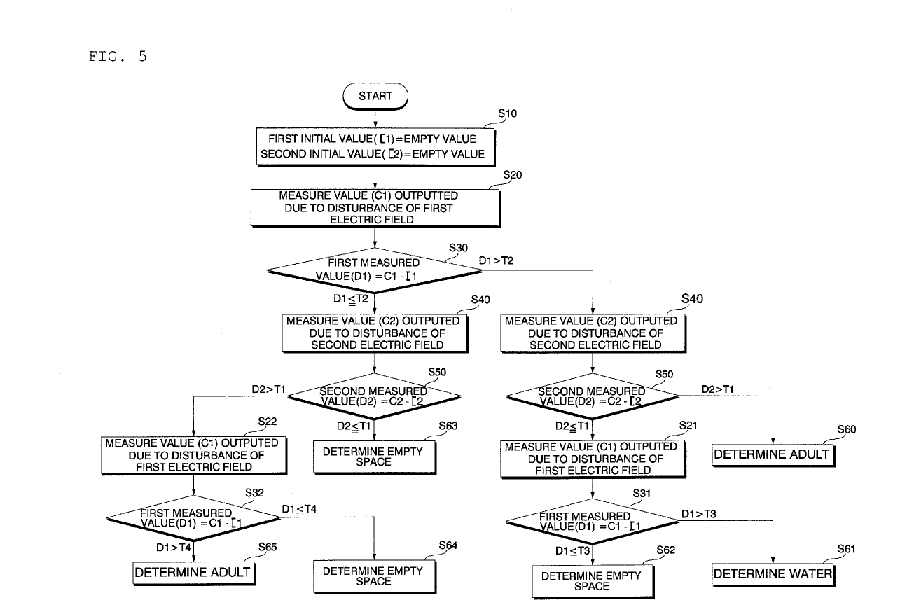

FIG. 5 is a flowchart illustrating a method of controlling an occupant classifying device for an automobile according to an exemplary embodiment of the present invention.

Referring to FIG. 5, the value outputted due to disturbance of the first electric field E1 when the seat 1 is empty is stored as a first initial value I1 and the value outputted due to disturbance of the second electric field E2 when the seat 1 is empty is stored as a second initial value I2, in the controller 46 (S10).

Thereafter, the controller 46 measures a value C1 outputted due to disturbance of the first electric field E1 in order to classify the object 7 in the seat 1 (S20).

A value obtained by subtracting the first initial value I1 from the value C1 outputted due to disturbance of the first electric field E1 is stored as a first measured value D1 in the controller 46 (S30).

Thereafter, the controller 46 measures a value C2 outputted due to disturbance of the second electric field E2 in order to classify the object 7 in the seat 1 (S40).

A value obtained by subtracting the second initial value 12 from the value C2 outputted due to disturbance of the second electric field E2 is stored as a second measured value D2 in the controller 46 (S50).

Thereafter, the controller 45 classifies the object 7 in the seat 1 by comparing the first measured value D1 with the predetermined critical values, comparing the second measured value D2 with the predetermined critical values, and selecting one of the classification modes in accordance with the comparing result. The predetermined critical values are a first critical value T1, a second critical value T2, a third critical value T3, and a fourth critical value T4, in this exemplary embodiment.

In detail, the controller 46 classifies the object 7 in the seat 1 as an adult by selecting the adult mode from the classification modes and finally determines the object 7 in the seat as an adult such that the airbag can inflate, when the first measured value D1 is larger than the second critical value T2 and the second measured value D2 is larger than the first critical value T1 (S60).

Further, the controller 46 measures again the value C1 outputted due to disturbance of the first electric field E1, when the first measure value D1 is larger than the second critical value T2 and the second measured value D2 is smaller than the first critical value T1 (S21). Therefore, a value obtained by subtracting the first initial value I1 from the value C1 outputted due to disturbance of the first electric field E1 is stored again as the first measured value D1 in the controller 46 (S31). Thereafter, the controller 46 classifies the object 7 in the seat 1 as water by selecting the water mode from the classification modes and finally determines the object 7 in the seat 1 as water such that the warning device can operate, when the first measured value D1 is larger than the third critical value T3 (S61). Further, the controller 46 classifies the object 7 in the seat 1 as an electronic device by selecting the electronic device-off mode from the classification modes and finally determines the object 7 in the seat 1 as an empty space such that the airbag does not inflate, when the first measured value D1 is smaller than the third critical value T3 (S62).

Further, the controller 46 classifies the object 7 in the seat 1 as an empty space or a CRS by selecting the empty mode or the CRS mode from the classification modes and finally determines the object 7 in the seat 1 as an empty space such that the airbag does not inflate, when the first measured value D1 is smaller than the second critical value T2 and the second measured value D2 is smaller than the first critical value T1 (S63).

Further, the controller 46 measures again the value C1 outputted due to disturbance of the first electric field E1, when the first measure value D1 is smaller than the second critical value T2 and the second measured value D2 is larger than the first critical value T1 (S22). Therefore, a value obtained by subtracting the first initial value I1 from the value C1 outputted due to disturbance of the first electric field E1 is stored again as the first measured value D1 in the controller (S32). Thereafter, the controller 46 classifies the object 7 in the seat 1 as an electronic device by selecting the electronic device-on mode from the classification modes and finally determines the object 7 in the seat 1 as an empty space such that the airbag does not inflate, when the first measured value D1 is smaller than the fourth critical value T4 (S64). Further, the controller 46 classifies the object 7 in the seat 1 as a cushion or thick cloth by selecting the cushion or thick cloth mode from the classification modes and finally determines the object 7 in the seat 1 as an adult such that the airbag can inflate, when the first measured value D1 is larger than the fourth critical value T4 (S65).

It will be understood to those skilled in the art that the present invention may be implemented in various ways without changing the spirit of necessary features of the present invention. Accordingly, the embodiments described above are provided as examples in the whole respects and do not limit the present invention. The scope of the present invention is defined in the following claims and all changed or modified types derived from the meanings and scope of the claims and the equivalent concept thereof should be construed as being included in the scope of the present invention.

What is claimed is:

1. An occupant classifying device for an automobile, comprising:
a car body;
a first electrode disposed in a seat inside the car body;
a second electrode disposed in the seat; and
a switch allowing the first electrode and the second electrode to have different polarities or the same polarity such that a first electric field is generated between the first electrode and the second electrode, or a second electric field is generated between the first and second electrodes and the car body.

2. The occupant classifying device for an automobile according to claim 1, further comprising:
a control unit including the switch to classify an object in the seat, in accordance with a value outputted due to disturbance of the first electric field, and a value outputted due to disturbance of the second electric field, the disturbance being generated by exposure of the object in the seat.

3. The occupant classifying device for an automobile according to claim 2, wherein the control unit further includes a controller that classifies the object in the seat by comparing the value outputted due to disturbance of the first electric field and the value outputted due to disturbance of the second electric field with predetermined critical values.

4. The occupant classifying device for an automobile according to claim 3, wherein the value outputted due to disturbance of the first electric field when the seat is empty is stored as a first initial value and the value outputted due to disturbance of the second electric field when the seat is empty is stored as a second initial value, in the controller.

5. The occupant classifying device for an automobile according to claim 4, wherein a value obtained by subtracting the first initial value from the value outputted due to disturbance of the first electric field is stored as a first measured value and a value obtained by subtracting the second initial value from the value outputted due to disturbance of the second electric field is stored as a second measured value, in the controller.

6. The occupant classifying device for an automobile according to claim 5, wherein a plurality of classification modes for classifying the object in the seat is set in advance in the controller, and
the controller classifies the object in the seat by comparing the first measured value with the predetermined critical values, comparing the second measured values with the predetermined critical values, and selecting one of the classification modes.

7. The occupant classifying device for an automobile according to claim 6, wherein the classification modes include an adult mode, an empty mode, and CRS mode, an electronic device-on mode, an electronic device-off mode, a cushion or thick cloth mode, and a water mode.

8. The occupant classifying device for an automobile according to claim 7, wherein the controller finally determines the object in the seat as an adult when classifying the object in the seat by selecting one of the adult mode and the cushion or thick cloth mode, finally determines the object in the seat at an empty space when classifying the object in the seat by selecting one of the empty mode, the CRS mode, the electronic device-on mode, and the electronic device-off mode, and finally determines the object in the seat as water when classifying the object in the seat by selecting the water mode.
